(19) United States
(12) Patent Application Publication
(10) Pub. No.: US 2016/0323317 A1
(43) Pub. Date: Nov. 3, 2016

(54) CONTROL OF DATA PROVISION WITH A PERSONAL COMPUTING DEVICE

(71) Applicant: ARM IP LIMITED, Cambridge (GB)

(72) Inventors: Andrew Pritchard, Cambridge (GB); Gabor Balint, Cambridge (GB)

(21) Appl. No.: 15/107,757

(22) PCT Filed: Dec. 10, 2014
(86) PCT No.: PCT/GB2014/053655

§ 371 Date: Jun. 23, 2016

(30) Foreign Application Priority Data
Dec. 23, 2013 (GB) 1322879.6

(51) Int. Cl. H04L 29/06; G06F 21/62

(52) U.S. Cl. CPC H04L 63/20; H04L 63/10; G06F 21/6245

(57) ABSTRACT

A personal computing device receives a request for data from a requester. The personal computing device determines whether or not that request is to be permitted or not permitted. The personal computing device indicates to the user both a data indication of what data has been requested by the requester and a policy indication of what policy (e.g. retention policy) is associated with that data. The personal computing device may take the form of a smart watch. The data indication may take the form of an icon and the policy indication may take the form of an icon overlaid upon the data icon.

### RELATED APPLICATIONS

The present application is a National Phase entry of PCT Application No. PCT/GB2014/053655, filed Dec. 10, 2014, which claims priority from GB Patent Application No. 1322879.6, filed Dec. 23, 2013, said applications being hereby incorporated by reference herein in their entirety.

### TECHNICAL FIELD

The invention relates to the field of data processing systems. More particularly, the invention relates to the control of the provision of data within data processing systems.

### BACKGROUND

Traditional data processing systems provide a request for data which is sent from a requester to a personal computing device. The personal computing device may permit the request and authorize the provision of data or may not permit the request in which case the provision of data is not authorized.

As the number of different types of data which may be provided by a personal computing device to a requester increases, and the user sensitivity to the release of such data also increases, there is a need to better inform the user of the nature of the data provision the user is authorizing in order that the user grow in confidence in the automated provision of such data. Furthermore, by better understanding the nature of the data provision being made, the user can make better decisions about whether or not such data provision should be authorized.

### SUMMARY

In an embodiment, a method of controlling provision of data comprises: sending a request for said data from a requester to a personal computing device, said request identifying said data and a policy to be associated with said data; receiving said request at said personal computing device; determining with said personal computing device if said request is a permitted request and (i) if said request is a permitted request, then authorizing said provision of said data to said requester; AND (ii) if said request is not a permitted request, then not authorizing said provision of said data to said requester.

Embodiments described herein identify that when data is being authorized for provision by a personal computing device, the provision may be better understood by considering it in two aspects. The first aspect is what data has been requested for provision. The second aspect is a policy associated with that data. In some embodiments there is provided combined data indications and policy indications and in this way, a wide variety of different combinations may be represented and yet readily understood by the user.

While it will be appreciated that the policy associated with the data can have a a number of different embodiments, in one form of policy it may be desired to represent is a retention policy to be applied by the requester to the data which is being requested. The retention policy can be, for example, selected from a predetermined group of retention policies which includes one or more of that the data should be permanently retained by the requester, the data is retained until completion of a transaction associated with the data, the data is retained for use by the requester to perform a predetermined processing task and thereafter will not be retained, the data is retained by the requester for a predetermined period of time, and the data is retained for use by the requester a predetermined number of times and thereafter is not retained.

While it is possible that the indication device could take a number of different forms, one embodiment of the indication device is a display screen of the personal computing device as such a display screen well suited to displaying indications of both data type and policy type.

The user understanding of the nature of the provision of data being requested can be increased in embodiments in which the data indication includes a data icon which identifies a data type of the data concerned and where the policy indication includes a policy icon identifying a policy type of a policy to be applied to the data. In this context, the policy icon can be overlaid on the data icon in a way so as to form a combined icon which is then more readily understood by the user, even though it represents one of a wide range of different combinations of data type and policy type.

In addition to indicating with an indication device of the personal computing device the data type and the policy type, in some embodiments there can be additionally provided a display screen associated with the requester and which also displays to the user the data indication and the policy indication. For example, the requester can be a remote server communicating with the personal computing device via a local terminal and a display screen on the local terminal can be associated with a session with the requester within which the data request has been made. Thus, a window in a web browser can represent a request made from a remote server and that window can display the data indication and the policy indication in addition to the data indication and policy indication being displayed upon the personal computing device. A user can view both the display on their personal computing device and the display upon the local terminal to check that the displays match thereby improving user confidence and user control over authorizing the provision of their data.

In some embodiments, the step of determining whether or not a request is to be authorized can include the personal computing device communicating with an authorizing server via a telecommunications link (such as the interne). With such embodiments, the authorizing server can generate the data indication and the policy indication for displaying on the screen associated with the requester thereby improving security by making it more difficult for another party to spoof the data indication and the policy indication presented to a user.

It will be appreciated that in some embodiments the personal computing device can itself directly provide the data being requested. However, in other embodiments, the processing load upon personal computing device can be reduced when the provision of the data is by a third party device to the requester. In such embodiments the personal computing device can authorize the third party device to provide the data to the requester by, for example, issuing a token to the requester using which token the requester can obtain the data sought from the third party device.

Whether or not a request is to be permitted can be validated by the personal computing device using permission data stored on the personal computing device. Such permission data can indicate that a request is automatically permitted and authorizes such a request without requiring any user input. Automatic requests can be ones associated with data of little sensitivity or with requesters in which the user of the personal computing device has already indicated that such requesters have a high degree of trust. Other forms of permission data can indicate that a request is optionally authorized, in which case the user will be presented with a prompt to which the user can respond by either authorizing or not authorizing the request. The permission data can additionally specify that certain requests are unauthorized requests, such as requests originating from requesters known to be untrustworthy or for types of data which the user does not wish to authorize using their personal computing device.

The personal computing device can comprise a number of different embodiments. For example, the personal computing device can comprise a wearable computing device.

In another embodiment, a personal computing device for controlling provision of data comprises: receiving circuitry configured to receive a request for said data from a requester, said request identifying said data and a policy to be associated with said data; determining circuitry configured to determine if said request is a permitted request and (i) if said request is a permitted request, then authorizing said provision of said data to said requester; and (ii) if said request is not a permitted request, then not authorizing said provision of said data to said requester; and an indicating device configured to provide a data indication of what data has been requested by said requester and a policy indication of what policy is associated with said data.

In another embodiment, a personal computing device for controlling provision of data comprises: receiving means for receiving a request for said data from a requester, said request identifying said data and a policy to be associated with said data; determining means for determining if said request is a permitted request and (i) if said request is a permitted request, then authorizing said provision of said data to said requester; and (ii) if said request is not a permitted request, then not authorizing said provision of said data to said requester; and indicating means for providing a data indication of what data has been requested by said requester and a policy indication of what policy is associated with said data.

### BRIEF DESCRIPTION OF THE DRAWINGS

Embodiments will now be described, by way of example only, with reference to the accompanying drawings in which

FIG. 1 is a block diagram of a computer system including a personal computing device, a local device, a requester, a third party device and a token issuing device;

FIG. 2 is a block diagram of an example of communication between the various entities in FIG. 1;

FIG. 3 is a flow diagram schematically illustrating request processing by the local device;

FIG. 4 is a flow diagram schematically illustrating request processing by the requester;

FIG. 5 is a flow diagram schematically illustrating request processing by the personal computing device;

FIG. 6 is a flow diagram schematically illustrating request processing by the third party device;

FIG. 7 is a flow diagram schematically illustrating request processing by the token issuing device;

FIG. 8 is a block diagram of interaction between the personal computing device and the local device;

FIG. 9 is a flow diagram schematically illustrating lock control of a login data store;

FIG. 10 is a flow diagram schematically illustrating login data provision by the terminal device (local device);

FIG. 11 is a flow diagram schematically illustrating authorized state switching by a personal computing device;

FIGS. 12A, 12B, and 12C and 13A, 13B, and 13C are block diagrams for icons displayed on a personal computing device to indicate the type of data being authorized and/or requested;

FIG. 14 is a block diagram for an icon indicating that a request has been refused;

FIG. 15 is a block diagram for a wearable computing device in the form of a watch on which a user input is required in order to confirm authorization of a request for data;

FIG. 16 is a block diagram for the use of a data type icon and a policy icon associated with a request for the provision of data;

FIG. 17 is a block diagram for different types of policy icons; and

FIGS. 18, 19 and 20 are block diagrams of different combinations of data icons and policy icons with the policy icons overlaid upon the data icons.

### DETAILED DESCRIPTION OF THE DRAWINGS

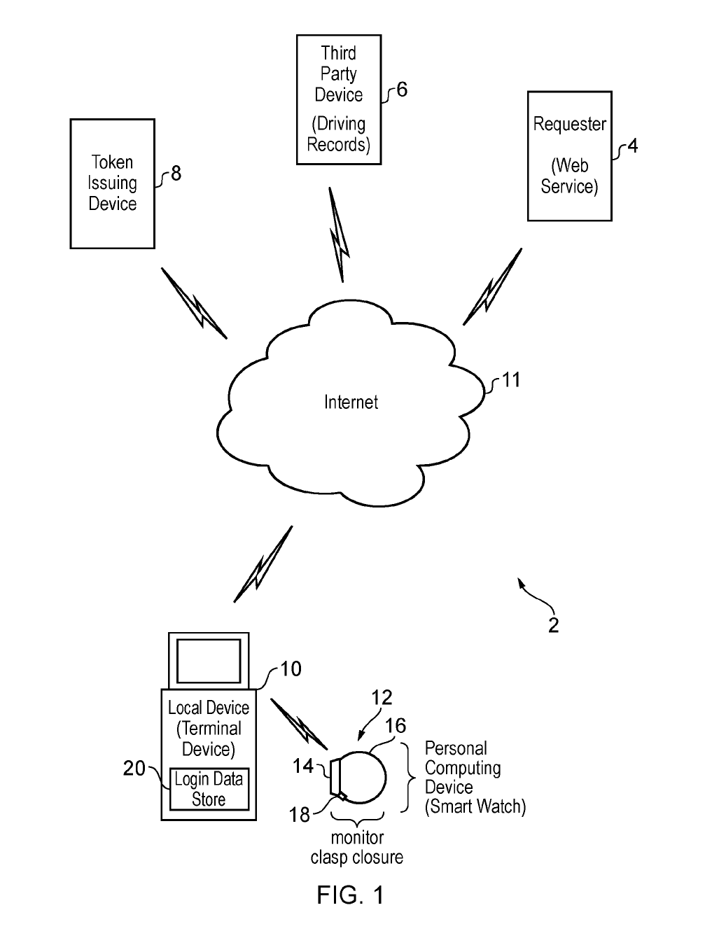

FIG. 1 is a block diagram of a computer system 2 including a requester 4, which provides a web service, a third party device 6, which provides, for example, driving records, a token issuing device 8 and a local device 10 all communicating via the internet 11 which serves as both a token-issuing telecommunications connection and a third-party telecommunications connection. A personal computing device 12 in the form of a smart watch having a watch body 14, a strap 16 and a clasp 18 is in two-way wireless communication with the local device 10 when proximal thereto. The closure of the clasp 18 is monitored by the smart watch 12 such that if the clasp 18 is opened so that the watch can be removed from a user's arm, then this is detected by the smart watch 12 and serves to switch the smart watch 12 from an authorized state to an unauthorized state.

The local device 10 can be a desktop personal computer, a laptop computer, a workstation or some other form of device. The local device 10 includes a login data store 20 which stores a plurality of items of login data. The login data includes user identifiers and associated passwords for different websites and web services as well as other associated data as necessary. The login data store serves as a “keyring” for the login data and the login data store can be in either a locked state or an unlocked state. When the login data store is in an unlocked state, then login data is automatically provided from the login data store to the requester 4. This behavior using the login data store 20 will be described further below.

The personal computing device 12 is in two-way wireless communication with the local device 10. The communication can use low energy Bluetooth radio connections (BLE). The radio connections can be adapted so as to detect the proximity of the personal computing device 12 to the local device 10. This proximity can be compared with a threshold level of proximity so as to control aspects of the operation of a local device 10 as will be described further below. The proximity can be determined based upon a proximity metric which is determined based upon the wireless signal.

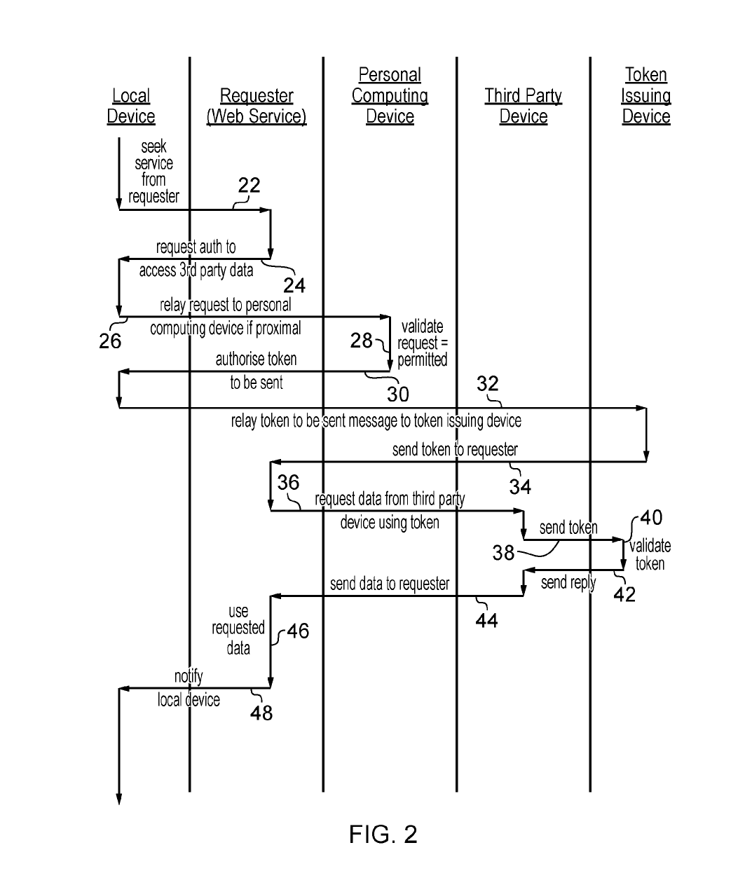

In FIG. 2, a block diagram of an example of the communication between the local device 10, the requester 4, the personal computing device 12, the third party device 6 and the token issuing device 8 is illustrated. This communication arises as a consequence of the local device 10 seeking a service from the requester 4, such as seeking to access a web based service, such as car rental. When the local device 10 seeks the service from the requester 4, the local device 10 can request display of a webpage which indicates that the requester 4 requires some data to be supplied in order that the requester 4 can provide the web service. As an example, the requester 4 can require personal identity and address details, or driving records, from a user in order to complete an online car rental booking. At step 22 in FIG. 2 the local device 10 communicates with the requester 4. At step 24 the requester 4 sends a request to authorize a data access to third party data held by the third party device 6 back to the local device 10. As an example, the third party device 6 can store driving records for the individual seeking to make a car rental. At step 26, the local device 10 which receives the request from the requester 4 via the internet 12 serves to relay the request to the personal computing device 12 via the short range Bluetooth wireless communication with the personal computing device 12. At step 28, the personal computing device 12 serves to validate the received request and determine whether that request is permitted or not permitted. If the request is permitted, then steps 30 and 32 send a message to the token issuing device 10 that a token for authorizing access is to be sent from the token issuing device 8 to the requester 4 at step 34. This token permits the requester 4 to send a request for data to the third party device at step 36. The third party device 6 then forwards the token received from the requester 4 to the token issuing device 8 at step 38. The token issuing device at step 40 validates this token and, if valid, sends a reply at step 42 to the third party device 6 indicating that the token is valid. Upon receipt of such a message indicating that the token is valid, the third party device 6 at step 44 sends the data that was requested to the requester 4, e.g. sends the driving records for the owner of the personal computing device 12. At step 46, the requester 4 uses the requested data, such as by checking that the user has a satisfactory driving record, to permit them to rent a car. At step 48 a notification is sent to the local device that the requester 4 has received and used the data from the third party device 6.

Access tokens are used by a client to prove that the client has prior authorization from an authenticating party to a perform actions on a validating party, typically a resource server. Access tokens can take many forms, for example API keys or OAuth tokens, but generally fall in to one of two categories.

Bearer tokens can contain lists of permissions and describe the conditions under which such tokens are granted. For example, until a certain date, these particulars or a digest of them being signed by the issuer using their private key such that the validating party, being in possession of the issuer's public key, can assure itself that the token was indeed issued by said issuing party. Security tokens can be validated directly by the validating party without recourse to any other party.

Security tokens are simply strings of characters, long enough to be difficult to guess correctly. In general, security tokens should only be passed over encrypted connections to authenticated parties. Security tokens can be accompanied by further information, such as the identity of the issuer. An API request containing such a key will be accepted by the party receiving the request provided the request is permitted by the permissions associated with the token. The permissions can be changed or revoked at any time. Third parties can issue tokens provided the third party either apprises the receiving party of each new token before the new token is first used, or the receiving party accepts validation requests to validate the keys on behalf of the receiving parties.

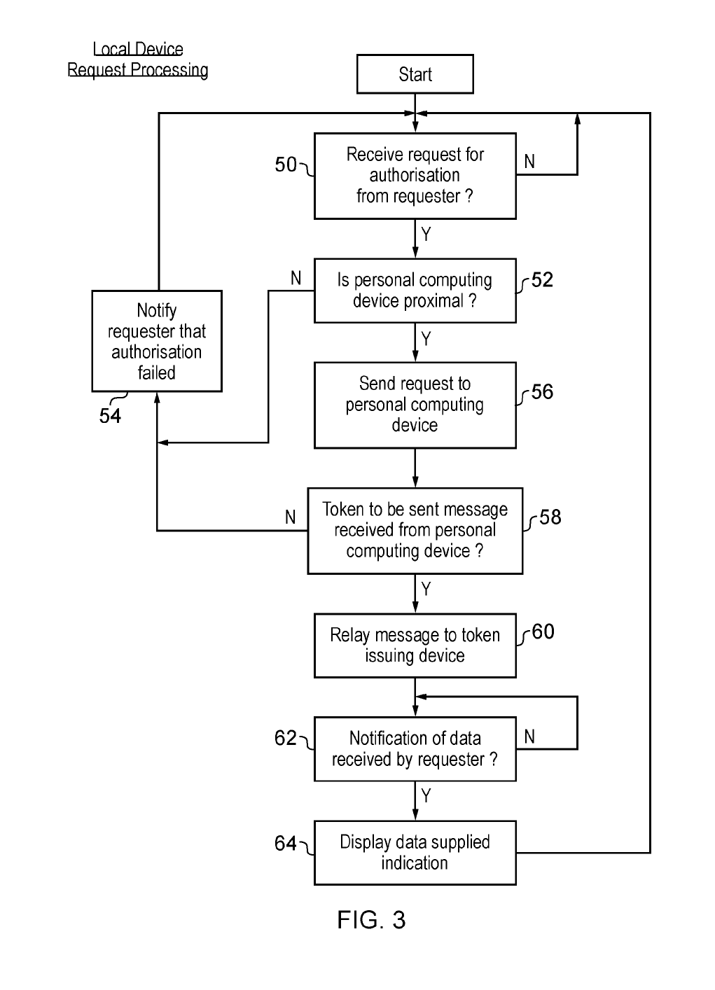

FIG. 3 is a flow diagram schematically illustrating request processing by the local device 10. At step 50 processing waits until a request for authorization is received from a requester 4. At step 52 a determination is made by the local device 10 based upon comparing the signal strength for two-way communication with the personal computing device 12 with a threshold level in order to determine whether or not the personal computing device 12 is proximal to the local device 10. If the personal computing device 12 is not proximal to the local device 10, then step 54 serves to notify the requester 4 that the authorization has failed. If the determination at step 52 is that the personal computing device 12 is proximal to the local device 10, then step 56 serves to send the request from the local device 10 to the personal computing device 12.

At step 58, the local device 10 waits to receive a message from the personal computing device 12 as to whether or not a message is to be sent to the token issuing device 8 indicating that the token issuing device should issue a token to the requester 4. If the message received at step 58 is that the token issuing device 8 should not send a token to the requester 4, then processing proceeds to step 54 and the requester 4 is notified that the authorization has failed. If the message received at step 58 is that a message is to be sent to the token issuing device 8, then step 60 serves to relay such a message from the personal computing device 12 to the token issuing device 8. Processing then waits at step 62 for notification from the requester 4 that the requester 4 has received its data following a successful interaction with the token issuing device 8 and the third party device 6. When such a notification is received, then step 64 serves to display on the local device an indication of what data has been supplied.

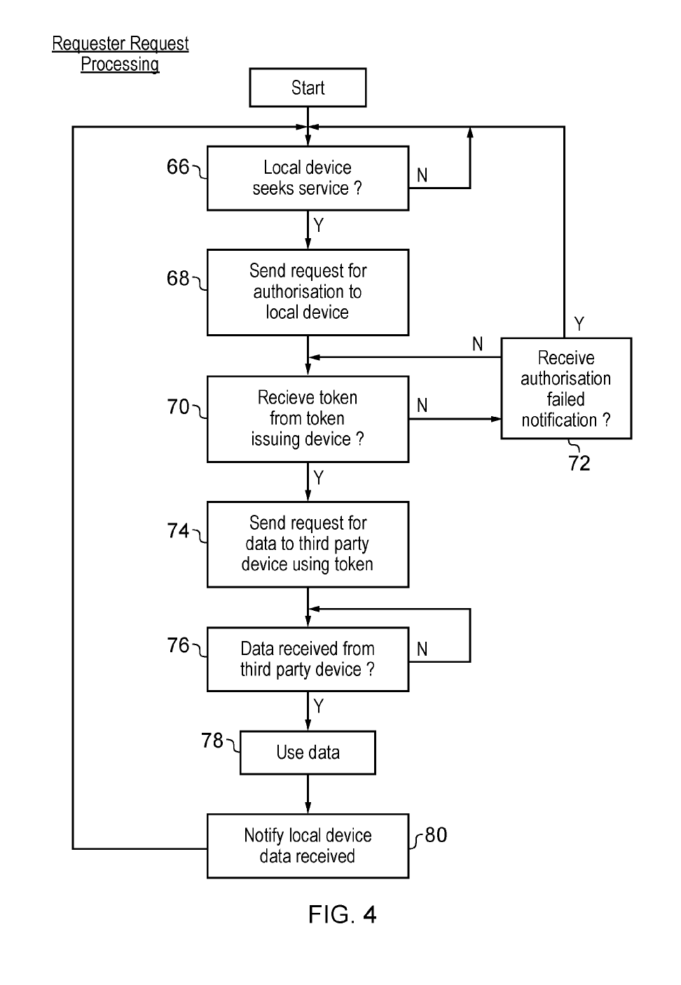

FIG. 4 is a flow diagram schematically illustrating request processing by the requester 4. Processing waits at step 66 until a local device 10 requests a service from the requester 4. At step 68 the requester 4 sends a request for authorization for data needed to fulfill the service to the local device 10. Processing then proceeds through steps 70 and 72 to identify that either a token has been received from the token issuing device 8 to be used to perform the access or that an authorization failed notification has been received. If an authorization failed notification is received, then processing proceeds to step 66 and the service requested is denied. If a token is received from the token issuing device at step 70, then processing proceeds to step 74 where the requester 4 sends a request for the data being sought to the third party device 6 accompanied with the token received from the token issuing device 8. The requester 4 then waits at step 76 for the data to be received from the third party device 6. When the data is received, step 78 uses this data, such as ensuring that a driver has an appropriate driving record for the car rental being set up, and processing then proceeds to step 80 where a message is sent to the local device 10 to notify the local device that the data has been received.

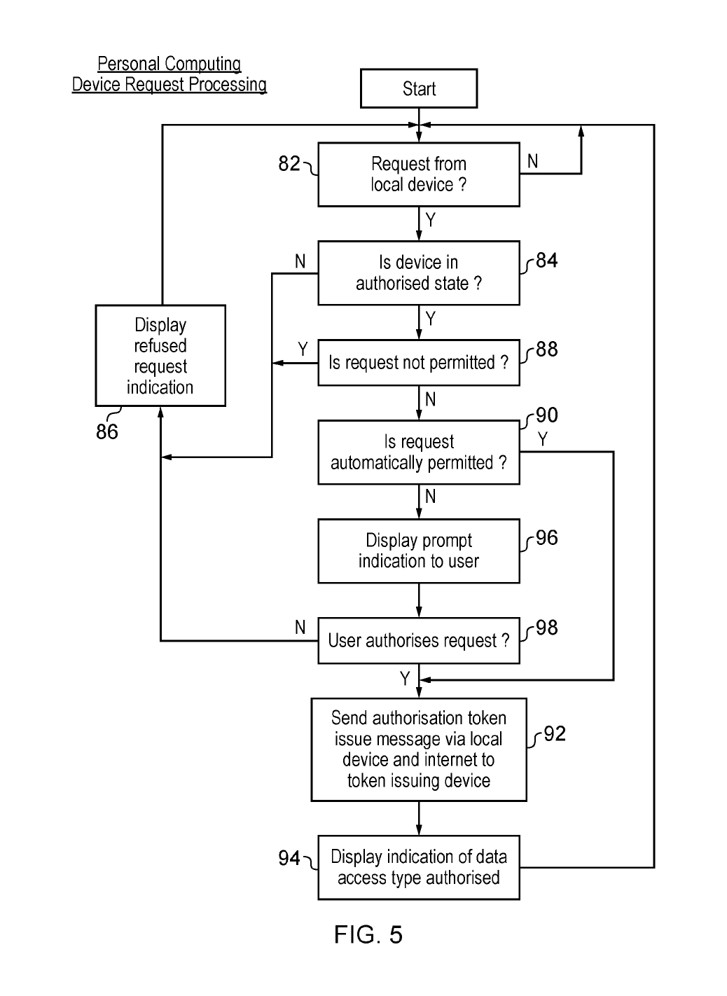

FIG. 5 is a flow diagram schematically illustrating request processing performed by the personal computing device 12. At step 82 the personal computing device 12 waits for a request to be received from the local device 10. When such a request is received, then step 84 determines whether or not the personal computing device 12 is currently in its authorized state or its unauthorized state. If the personal computing device 12 is in its unauthorized state, then processing proceeds to step 86 where a refused request indication is displayed by the personal computing device 12 and processing returns to step 82.

If the determination at step 84 is that the personal computing device 12 is in its authorized state, then step 88 determines whether or not the request is a permitted request. This can be achieved by comparing the request with permission data stored within the personal computing device 12. This permission data can indicate different types of data which are permitted to be authorized for distribution and/or different requesters who can be authorized in respect of different types of data or individual items of data or combinations of the preceding. It will be appreciated that the permission data can include a wide variety of different forms.

If the determination at step 88 is that the request is not permitted, then processing again proceeds to step 86. If the determination at step 88 is that the request is permitted, then processing proceeds to step 90 where a determination is made as to whether or not the request is one classified as automatically permitted. If the request is automatically permitted, then processing proceeds to step 92 where a message to send an authorization token is sent to the token issuing device 8 via the local device 10. Step 94 then displays an indication on the personal computing device of the type of data access that has been authorized. This indication can be, for example, in the form of displaying an associated type of icon indicating the nature of the data for which authorization has been granted.

If the determination at step 90 is that the request is not an automatically permitted request, then step 96 displays a prompt indication to the user of the personal computing device so as to prompt the user to make a user input to either authorize the request or not authorize the request. The user input can, for example, press a button to indicate that the request is either authorized or not authorized, enter a personal identification number to authorize a request, tap an icon on a screen to authorize a request or some other predetermined user input. Step 98 determines from the user input whether or not the request is authorized. If the request is not authorized, then processing proceeds to step 86. If the request is authorized, then processing proceeds to step 92.

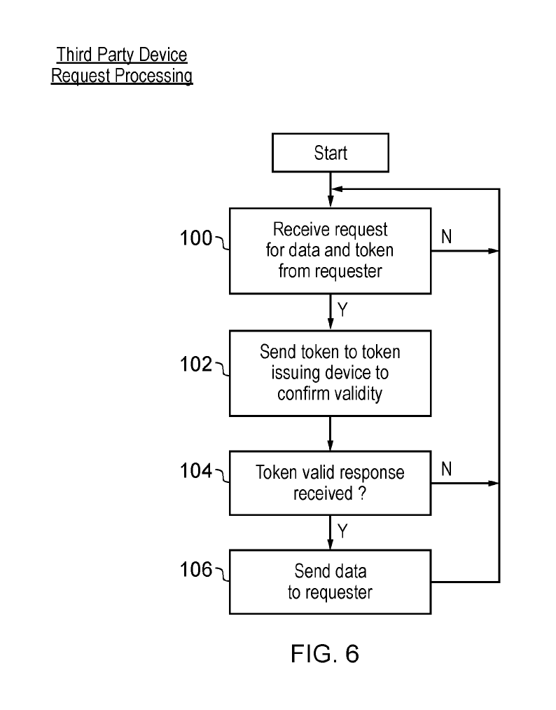

FIG. 6 is a flow diagram schematically illustrating request processing performed by the third party device 6. At step 100 the third party device 6 waits until a request for data and an associated token is received from the requester 4. When such a request and token are received, then step 102 sends the token to the token issuing device 8 associated with that token. Step 104 then waits until a token response is received and determines whether this token response is a token valid response. If the token response was a token valid response, then step 106 sends the data requested to the requester 4. If the token response was not that the token is valid, then processing returns to step 100.

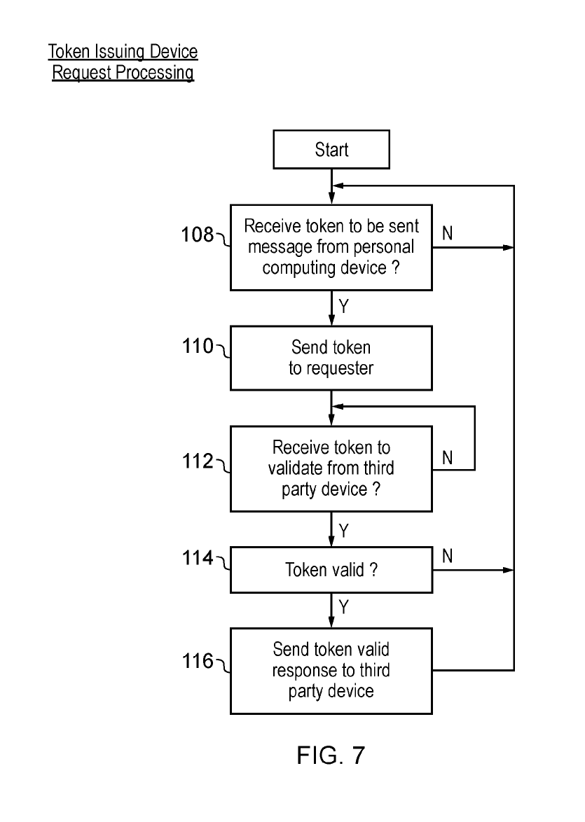

FIG. 7 is a flow diagram schematically illustrating request processing by the token issuing device 8. At step 108 processing waits until a message is received from the personal computing device 12, as relayed by the local device 10, that a token authorizing access should be sent to the requester 4. When such a message is received at step 108, step 110 sends the associated token from the token issuing device 8 to the requester 4. At step 112, the token issuing device, at least in association with the token that has been issued, waits to receive back from a third party device 6 the token sent to the requester 4 in order to validate that token. When a candidate token is received, step 114 determines whether or not the candidate token is valid. If the token is valid, then processing proceeds to step 116 at which a token valid response is sent to the third party device 6, which will in turn authorize the third party device 6 to send the requested data to the requester 4. If the determination at step 114 is that the token is not valid, then processing proceeds to step 108.

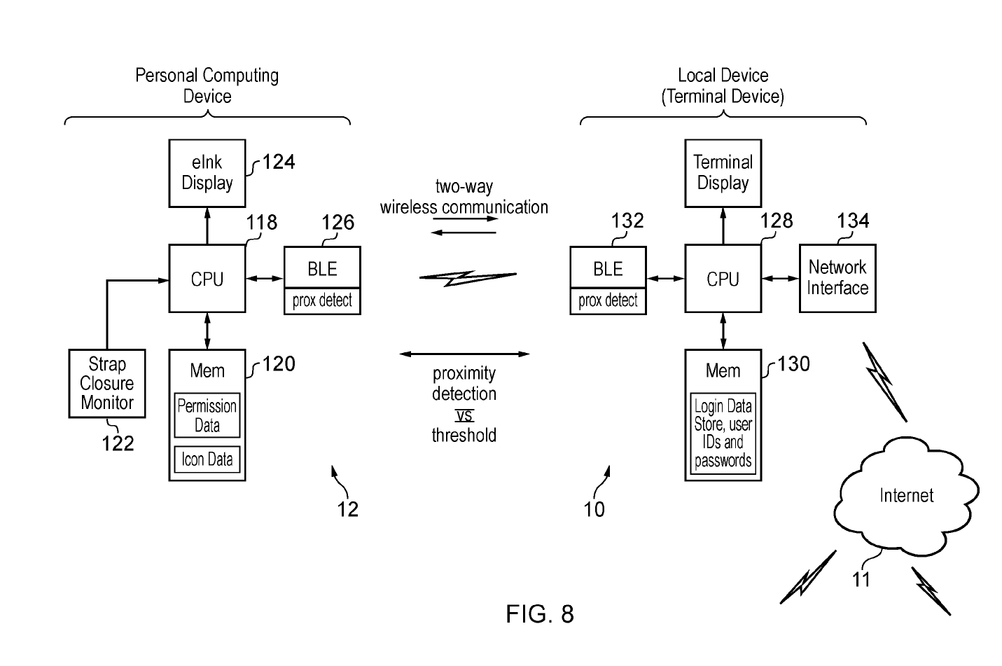

FIG. 8 is a block diagram of interaction between the personal computing device 12 and the local device 10. The personal computing device 12 includes a processor 118, a memory 120, a strap closure monitoring circuit 122, a display 124 and a Bluetooth Low Energy Transmitter/Receiver circuit 126. The memory 120 stores permission data specifying which requests will and will not be authorized, and whether or not those requests are automatically authorized or are optionally authorized requests. Optionally authorized requests require a predetermined user input following display of a prompt indication in order to authorize the data to which the requests relate to be released. The memory 120 also stores icon data defining icons which are displayed to indicate which types of data are being authorized to be released (or requested) as will be described later. The Bluetooth circuit unit 126 includes signal strength monitoring circuitry which serves to detect the proximity of the local device 10 to the personal computing device 12. This proximity can be compared with a threshold level of proximity in order to determine, at least in part, whether the personal computing device 12 is proximal to the local device 10.

According to embodiments, the memory 120 stores a computer program that is executed by the processor 118. Such a processor 118 operating under program control can serve as, for example, state determining circuitry for determining whether or not the personal computing device 12 is in an authorized state, permission determining circuitry for comparing a received request with the stored permission data and circuitry serving to either authorize or not authorize provision of data from the third party device 6 to the request 4 in accordance with the above discussions. In general, the processor 118 operating under program control, as well as other processors within the system, can provide various forms of circuitry for performing specified functions. As will be familiar to those in this technical field, particular specified functions can be performed either with a program general purpose processor or with dedicated circuitry depending upon the design requirements. Circuitry for performing the various functions described herein can be provided in any suitable manner.

The local device 10, which can be a terminal device in the form of a personal computer, includes a processor 128, a memory 130, a Bluetooth Low Energy Transmitting/Receiver circuit 132 for communicating with the personal computing device 12, and a network interface 134 for communicating with the internet 11. The memory 130 stores a login data store comprising a list of usernames and passwords associated with different websites or web services. This login data store can take the form of a password keyring which is either locked or unlocked. When the login data store is unlocked, then if the local device 10 accesses a webpage or web service that requires a password to be entered, then if this password is present within the unlocked login data store, the username and password are automatically provided so as to unburden the user from the need to perform this task. The same process can also be applied to logging on to a computer itself. In many embodiments, the process can be seamless such that the login process takes place without any user intervention.

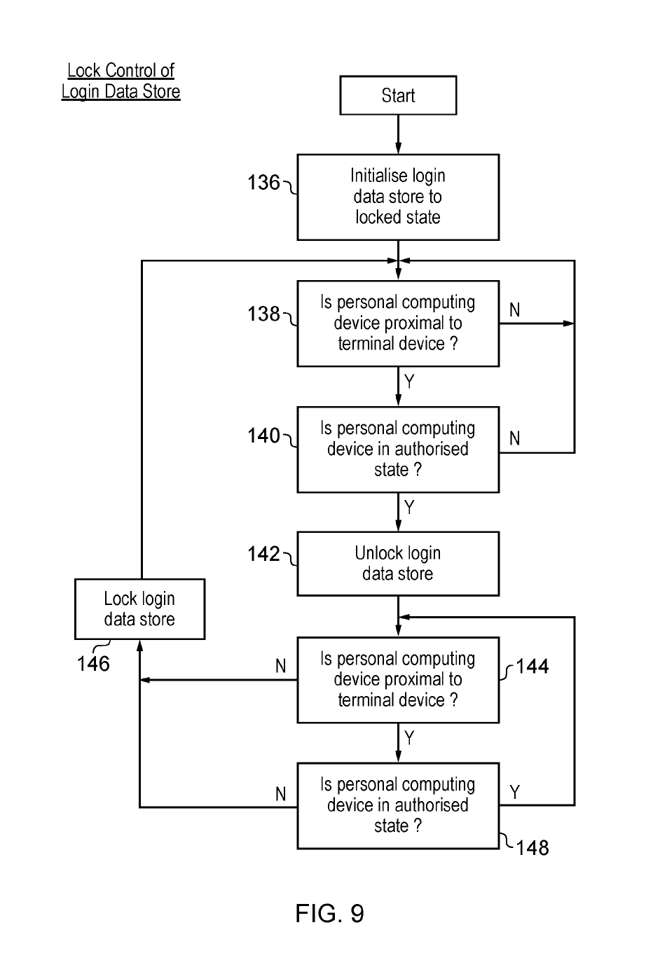

FIG. 9 is a flow diagram schematically illustrating lock control of the login data store by the local device 10. At step 136 the login data store is initialized into a locked state. At step 138 a determination is made as to whether or not the personal computing device 12 is proximal to the local device (terminal device) 10. If the personal computing device is not proximal to the terminal device 10, then processing waits at step 138. When the personal computing device 12 becomes proximal to the terminal device 10, then processing proceeds to step 140 where a determination is made as to whether or not the personal computing device is in its authorized state. The personal computing device 12 reports this state to the terminal device 10. If the personal computing device is not in its authorized state, then processing again returns to step 138. If the personal computing device 12 is in its authorized state, then step 142 serves to switch the login data store into its unlocked state. Step 144 then determines whether or not the personal computing device remains proximal to the terminal device 10. If the personal computing device 12 is not proximal to the terminal device 10, then step 146 serves to switch the login data store from its unlocked state to its locked state. If the determination at step 144 is that the personal computing device 12 remains proximal to the terminal device 10, then step 148 also serves to determine that the personal computing device 12 remains in its authorized state before returning to step 144. If the personal computing device 12 is not in its authorized state, then processing again proceeds to step 146. Accordingly, steps 144 and 148 in combination serve to maintain the login data store in the unlocked state providing the personal computing device 12 remains proximal to the terminal device 10 and the personal computing device 12 remains in its authorized state.

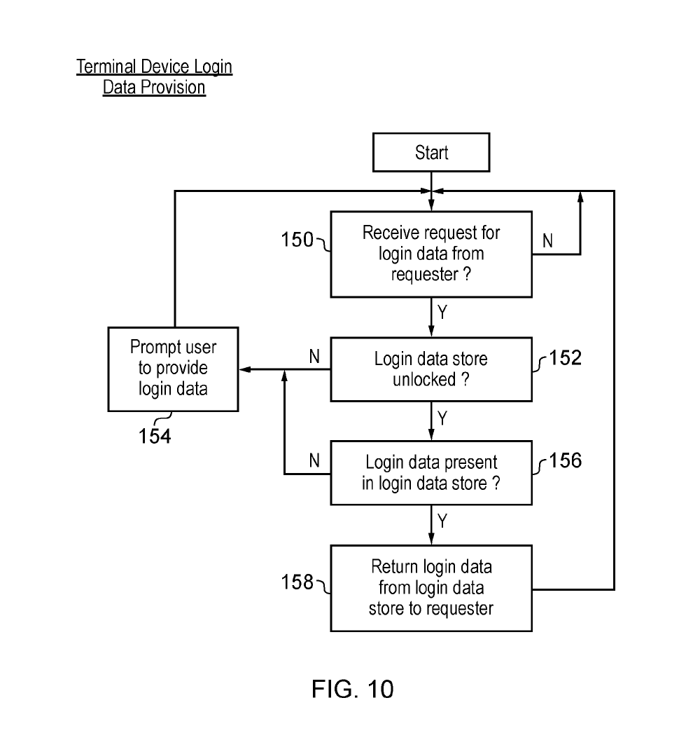

FIG. 10 is a flow diagram schematically illustrating login data provision by the terminal device 10. At step 150 processing waits until the terminal device 10 receives a request for login data from a requester 4. Step 152 determines whether the login data store is in its unlocked state. If the login data store is not in its unlocked state, then processing proceeds to step 154 where the user is prompted to provide manually the login data requested. If the determination at step 152 is that the login data store is unlocked, then step 156 accesses this login data and determines whether or not the login data store contains the login data being requested at step 150. If the login data store does not contain the requested login data, then processing again proceeds to step 154. If the determination at step 156 is that the login data store does contain the requested login data, then step 158 serves to return this login data to the requester 4 without requiring user input by the user. An indication that such login data had been automatically provided can be displayed to the user via the terminal device 10 and/or the personal computing device 12.

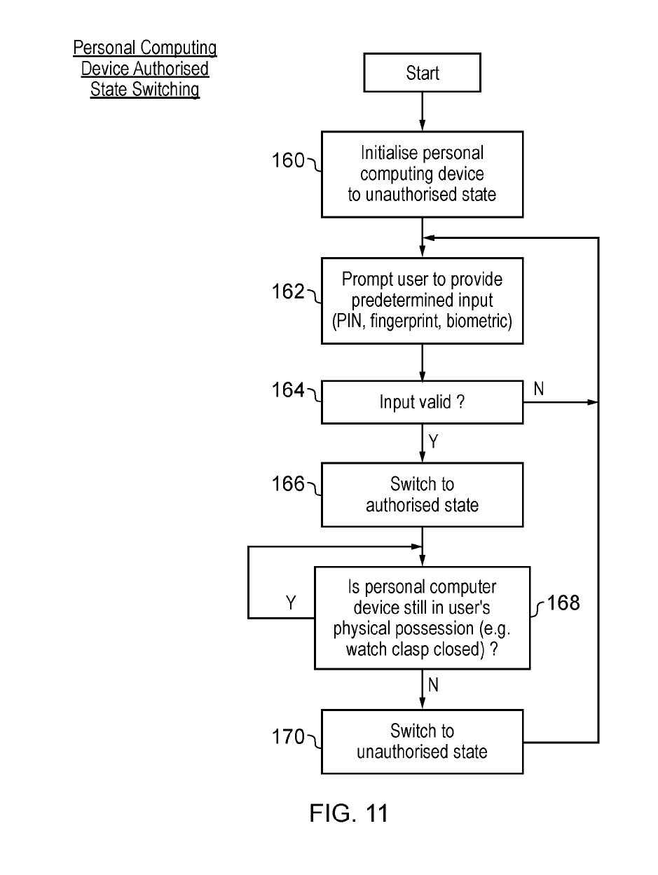

FIG. 11 is a flow diagram schematically illustrating authorized state switching performed by the personal computing device 12. At step 160 the personal computing device 12 is initialized into an authorized state. Step 162 then displays a prompt to the user to make a predetermined input in order to switch the personal computing device 12 from the unauthorized state to the authorized state. Such a predetermined input can take a variety of different forms, such as entering a personal identification number, scanning a fingerprint, scanning of another biometric parameter, or various other ways of validating a user.

Step 164 determines whether the user input at step 162 was valid. If the user input was not valid, processing returns to step 162 and the personal computing device 12 remains in the unauthorized state. If the input received at step 162 was valid, then step 166 serves to switch the personal computing device 12 from the unauthorized state to the authorized state. Processing then passes to step 168. Step 168 serves to continuously monitor that the personal computing device 12 remains under the user's physical possession. This can, for example, be carried out by monitoring the closure of the watch clasp 18 to ensure that this remains closed indicating that the watch strap 16 and the watch body 14 are attached to the user. Other forms of confirmation of physical possession are also possible, such as monitoring biometric parameters of the user, such as heart activity, characteristic motion etc. If the determination at step 168 at any time is that the personal computing device 12 has ceased to be in the continued physical possession of the user, then processing proceeds to step 170 where the personal computing device 12 is switched from the authorized state back to the unauthorized state and processing is returned to step 162.

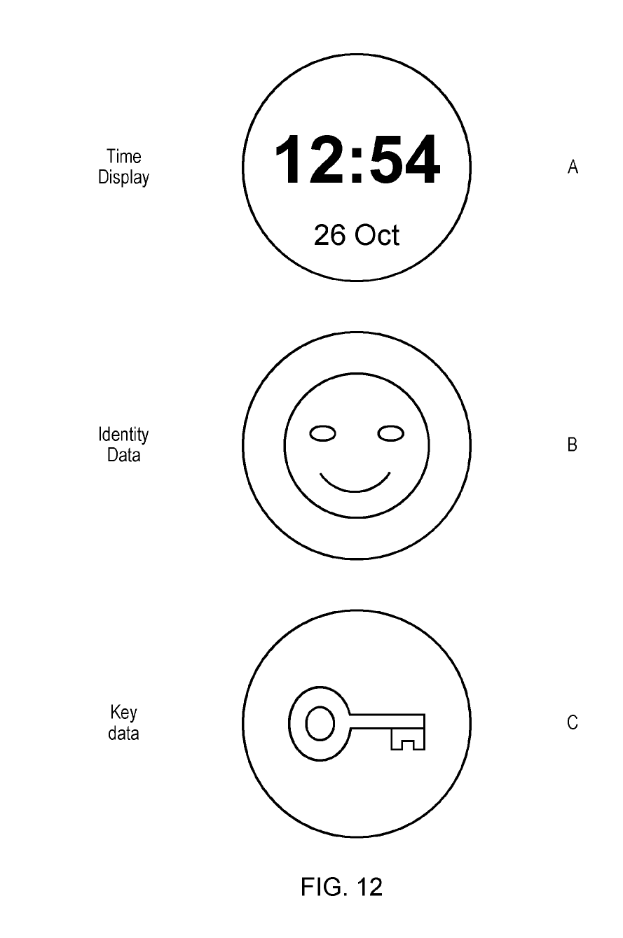

FIGS. 12A-12C, 13A-13C and 14 are block diagrams of displays which can be presented to the user on the personal computing device 12. FIG. 12A illustrates a normal time display when the personal computing device 12 is being used as a watch. FIG. 12B illustrates an icon which is displayed when identity data is being authorized for provision to the requester 4 or, at least requested. The use of a small set of known icons to represent the data being authorized allows the user to determine which actions are being taken by the personal computing device 12 and what data is being released to the requester 4. FIG. 12C illustrates an icon which is displayed when key data is being provided. This key data can be, for example, password data and username data of a wide variety of different forms used to control access to an account or service in one of many known ways.

FIGS. 13 A, B, C respectively indicate icons displayed where the data authorized for provision is insurance data, vehicle related data and health data of the user. The data authorized for provision is stored by the third party device 6. Different types of data can be stored in different third party devices. For example, insurance data can be held within the web server of an insurance company whereas health data can be held within the web server of a health provider.

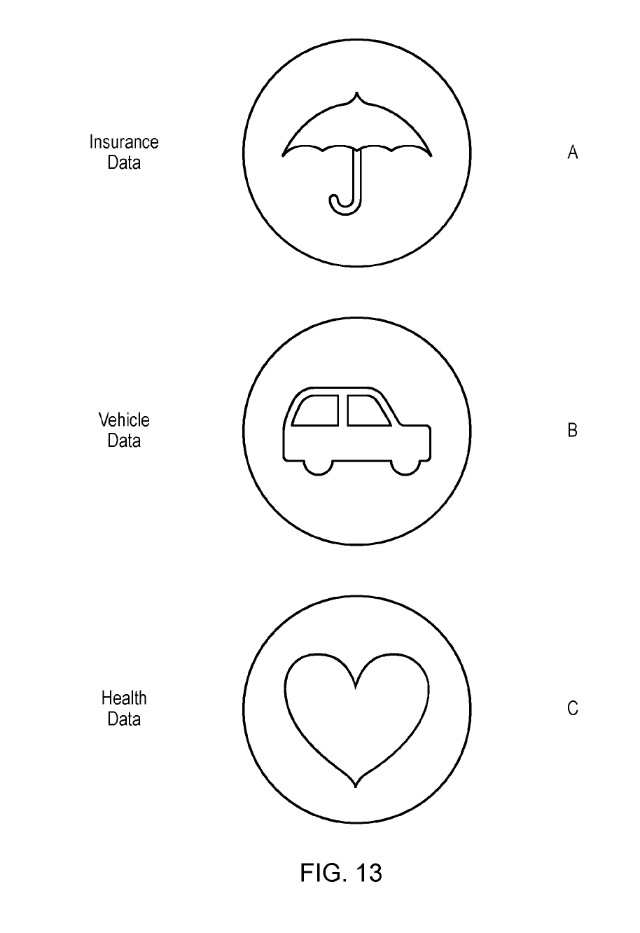

FIG. 14 is a block diagram for an indication which is displayed to the user when a request for authorization to access data is refused. This icon is in the form of a no entry sign.

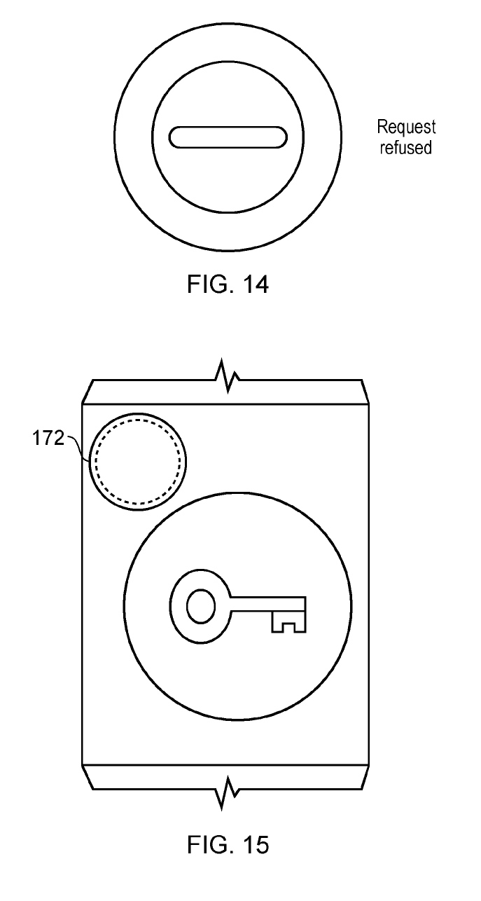

FIG. 15 is a block diagram for a personal computing device 12 in the form of a smart watch in which an icon is displayed indicating that key data is potentially authorized for release (e.g. in response to an optionally authorized request). The personal computing device 12 includes a user activated button 172 which the user can press within a predetermined period to authorize the request for release of key data. The button 172 can be illuminated when a user input (or not) using the button is required.

The display of icons as illustrated in FIGS. 12, 13, 14 and 15 indicating the type of data to be released, provides a back channel of communication to the user of the personal computing device 12 to permit them to more readily understand the nature of the authorizations being requested and made.

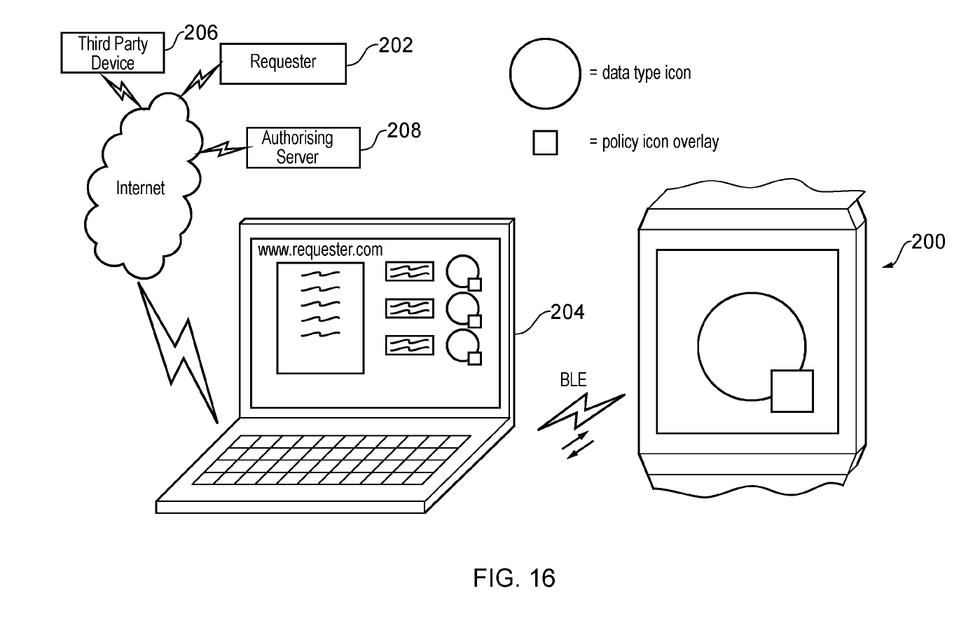

FIG. 16 is a block diagram for a data processing system including a personal computing device 200, which receives a request to authorize the provision of data from a requester 202. This request is passed via the internet and a local terminal 204 using internet connections and a wireless two-way communication link between the local terminal 204 and the personal computing device 200. Also communicating via the internet are a third party device 206, which stores the data being requested, and an authorizing server 208 which can authorize the requester 202 to retrieve the data from the third party device 206. The authorizing server 208 can be instructed by the personal computing device 200 to issue a token to the requester 202. This token can be sent by the requester 202 to the third party device 206 accompanying their request for data and the third party device 206 can validate the authenticity of the token with the authorizing server 208 before returning the requested data to the requester 202.

The requester 202 can request the data as a consequence of a request for a web service initiated by a user of the personal computer device 200 using the local terminal 204. For example, the user can access a website associated with the requester 202 and seek to obtain services of the requester 202. The requester 202 can display its webpage, as illustrated in FIG. 16, and use icons supplied by the authorizing server 208 to indicate the nature of the data that the requester 202 is requesting as well as a policy, such as retention policy, to be associated with the use of that data by the requester 202. In another embodiment, the token is valid for a defined period of time and is accepted by the third part device without being further validated with the authorizing server. In such an embodiment the token can be issued by the personal device.

The retention policy can be selected from a group of predetermined retention policies including: the data is permanently retained by the requester, the data is retained until completion of a transaction associated with that data, the data is retained for use by the requester to perform a predetermined processing task and thereafter will not be retained by the requester, the data is retained by the requester for a predetermined period of time, and the data is retained for use by the requester for a predetermined number of times and thereafter will not be retained by the requester.

A set of policy icon overlays, each associated with a different one of these retention policies, can be stored and provided by the authorizing server 208 for display on the display of the local terminal 204 as illustrated. The same policy icons can also be displayed as overlays upon a data type icon on the display of the personal computing device, such as in the form of a wearable computing device, e.g. a smart watch. The person computing device 200 can store its own version of the icons as a double-check to indicate that the data type icon and the policy icon overlay displayed upon the personal computing device 200 match the data type icon and policy icon overlay displayed upon the display of the local terminal 204 and associated with the requester 202. In an embodiment, the personal computing device can display the data type icons and the policy icon overlays in sequence as the display of the personal computing device can, in some embodiments, be too small to display all of these icons simultaneously.

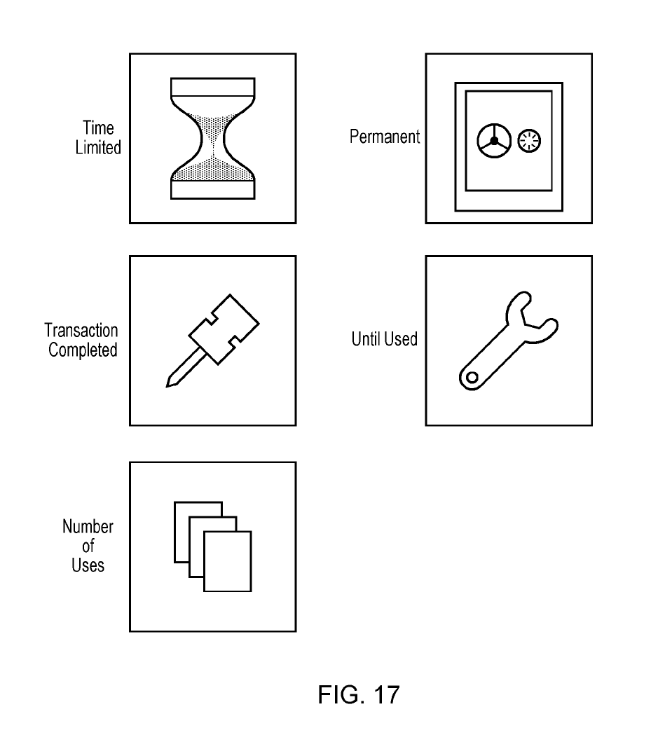

FIG. 17 is a block diagram for a variety of different types of policy icons. These icons can include an hour glass indicating a time limited policy whereby the data is retained by the requester for a predetermined period of time. Another example is an icon in the form of a safe indicating that the data will be permanently retained by the requester. Another example is in the form of a pin indicating that the data is retained until completion of the transaction associated with the data. Another icon is in the form of a tool indicating that the data is retained for use by the request to perform a predetermined processing task and thereafter will not be retained by the requester. Another policy icon overlay includes a sequence of pages indicating that the data is retained for use by the requester a predetermined number of times and thereafter will not be retained by the requester.

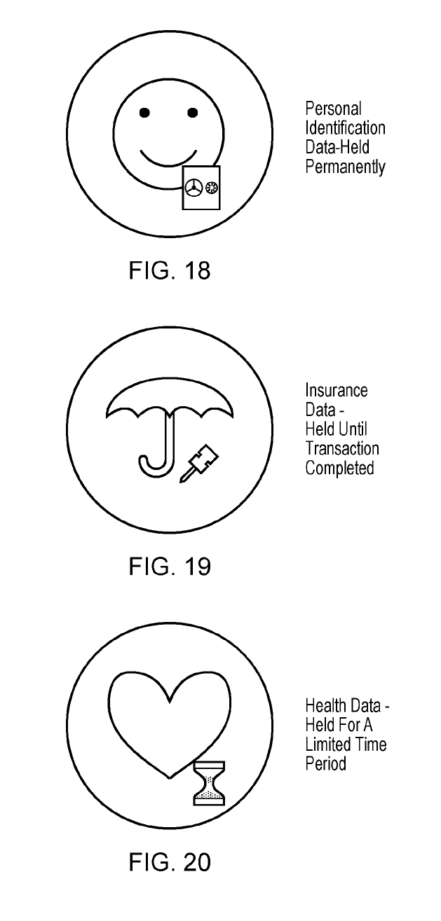

FIGS. 18, 19 and 20 are block diagrams depicting data icons with policy icons overlaid thereupon. Each of FIGS. 18-20 illustrates a display on the personal computing device 200 serving as a data indication of what data has been requested by the requester 202 and a policy indication of what policy (retention policy) is associated with that data. In the example of FIG. 18, personal identification data has been requested and this data will be held permanently by the requester 202. In the example of FIG. 19, insurance data has been requested and this data will be held by the requester 202 until the transaction has been completed. In the example of FIG. 20 health data has been requested and this data will be held by the requester 202 for a limited period of time. It will be appreciated that these same data icons and policy icons can be displayed upon the display of the local terminal 204 and can be matched by the user. The use of a relatively small number of icons to represent a wide number of different combinations facilitates user understanding of the nature of the data they are authorizing for provision and the policy to be applied to the retention of that data by the requester 202.

1. A method of controlling provision of data comprising:
sending a request for said data from a requester to a personal computing device, said request identifying said data and a policy to be associated with said data;
receiving said request at said personal computing device;
determining with said personal computing device if said request is a permitted request and
(i) if said request is a permitted request, then authorizing said provision of said data to said requester; and
(ii) if said request is not a permitted request, then not authorizing said provision of said data to said requester.

2. A method as claimed in claim 1, further comprising:
indicating with an indication device, of said personal computing device a data indication of what data has been requested by said requester and a policy indication of what policy is associated with said data.

3. A method as claimed in claim 1, wherein said policy is a retention policy for said data applied by said requester.

4. A method as claimed in claim 3, wherein said retention policy is selected from a predetermined group of retention policies.

5. A method as claimed in claim 4, wherein that said predetermined group of retention policies includes one or more of:
said data is retained permanently by said requester;
said data is retained until completion of a transaction associated with said data;
said data is retained for use by said requester to perform a predetermined processing task and thereafter will not be retained;
said data is retained by said requester for a predetermined period of time; and
said data is retained for use by said requester a predetermined number of times and thereafter will not be retained.

6. A method as claimed in claim 1, wherein said indication device is a display screen.

7. A method as claimed in claim 6, wherein said data indication includes a data icon identifying a data type of said data.

8. A method as claimed in claim 2, wherein said policy indication includes a policy icon identifying a policy type of said policy.

9. A method as claimed in claim 7, wherein said policy icon is overlaid on said data icon.

10. A method as claimed in claim 1, comprising displaying on a display screen associated with said requester said data indication of what data has been requested by said requester and said policy indication of what policy is associated with said data.

11. A method as claimed in claim 1, wherein said requester is a remote server communicating with said personal computing device via a local terminal device.

12. A method as claimed in claim 1, wherein said determining includes said personal computing device communicating with an authorizing server via a telecommunications connection.

13. A method as claimed in claim 10, wherein said authorizing server generates said data indication and said policy indication for display on said display screen associated with said requester.

14. (canceled)

15. A method as claimed in claim 1, wherein said personal computing device generates said data indication and said policy indication for display on said display screen of said personal computing device in dependence upon a data type and a policy type indicated by said request.

16. (canceled)

17. A method as claimed in claim 14, wherein if said permission data indicates said request is an automatically permitted request, then said personal computing device automatically authorizes said provision and at least one of said data indication and said policy indication indicates that said request has been authorized.

18. A method as claimed in claim 14, wherein if said permission data indicates said request is an optionally authorized request, then at least one of said data indication and said policy indication prompts a user of said personal computing device to provide a user input to one of (i) authorize said request whereupon said personal computing device authorizes said provision; and (ii) not authorize said request.

19. A method as claimed in claim 14, wherein if said permission data indicates said request is an unauthorized request, then said personal computing device does not authorize said provision.

20. A method as claimed in claim 14, wherein if said permission data indicates said request is an unauthorized request, then at least one of said data indication and said policy indication indicates that said request as not been authorized.

21. (canceled)

22. A personal computing device for controlling provision of data, said personal computing device comprising:
receiving circuitry configured to receive a request for said data from a requester, said request identifying said data and a policy to be associated with said data;
determining circuitry configured to determine if said request is a permitted request and
(i) if said request is a permitted request, then authorizing said provision of said data to said requester; and
(ii) if said request is not a permitted request, then not authorizing said provision of said data to said requester.

23. A personal computing device for controlling provision of data, said personal computing device comprising:
receiving means for receiving a quest for said data from a requester, said request identifying said data and a policy to be associated with said data;
determining means for determining if said request is a permitted request and
(i) if said request is a permitted request, then authorizing said provision of said data to said requester; and
(ii) if said request is not a permitted request, then not authorizing said provision of said data to said requester.

24-25. (canceled)
